(19) United States
(12) Patent Application Publication
(10) Pub. No.: US 2026/0112199 A1
(43) Pub. Date: Apr. 23, 2026

(54) METHOD, COMPUTER DEVICE AND COMPUTER-IMPLEMENTED COMPUTER PROGRAM PRODUCT USING FACIAL RECOGNITION TO MATCH PEOPLE WITH SIMILAR FACIAL FEATURES IN A GEOGRAPHIC AREA

(71) Applicant: Andy Eng, Bellevue, KY (US)

(72) Inventor: Andy Eng, Bellevue, KY (US)

(21) Appl. No.: 18/919,935

(22) Filed: Oct. 18, 2024

(51) Int. Cl. G06V 40/16

(52) U.S. Cl. CPC G06V 40/172; G06V 40/168

(57) ABSTRACT

A computer apparatus is provided and includes a memory device configured to store an instruction executable on a computer and at least one processor configured to execute the instruction. The processor includes a facial recognition module for identifying facial features of a user, a location module for determining the location of the user and a matching module for matching the facial features of the user to the facial features of other users in a distance range of the user and providing the user with information about the other users. A display device displays the results of the matching of the facial features withing a selected distance range and match percentage.

### BACKGROUND

The present application relates generally to a method, computer device and computer-implemented computer program product and more particularly, to a computer program and method that uses facial recognition program to match people with similar facial features at a geographic location and display the matched people to a user.

People often want to find other people who look like them. This can be for a variety of reasons, such as finding a lost twin, making new friends, or simply finding someone who looks familiar. However, it can be difficult to find other people who look like you, especially if you are in a new place or location.

It is therefore desirable to provide a computer program and method that uses a facial recognition program to match people with similar facial features at a designated geographic place or location.

### SUMMARY

The present invention is a method, computer device and computer-implemented computer program product that uses a facial recognition program to match people with similar facial features at a geographic location and display the matched people to a user.

In an embodiment, a computer apparatus is provided and includes a memory device configured to store an instruction executable on a computer and at least one processor configured to execute the instruction. The processor includes a facial recognition module for identifying facial features of a user, a location module for determining the location of the user and a matching module for matching the facial features of the user to the facial features of other users in a distance range of the user and providing the user with information about the other users. A display device displays the results of the matching of the facial features withing a selected distance range and match percentage.

In another embodiment, a matching method performed by at least one processor of a computer apparatus, where the method includes identifying facial features of a user, determining a location of the user, selecting a distance range relative to the location of the user, selecting a match percentage associated with the facial features of the user and other users in the selected distance range, matching the facial features of the user to facial features of other users in the selected distance range of the user, storing information on the other users that have similar facial features to the user and displaying the information on a display device to the user.

### BRIEF DESCRIPTION OF THE DRAWINGS

FIG. 1 is a schematic diagram of an embodiment of a computer network.

FIG. 2 is a schematic diagram of an embodiment of a mobile device.

FIG. 3 is a block diagram illustrating steps of the computer program implemented on a mobile device.

FIG. 4 is a front view of a mobile device implementing an embodiment of the computer program showing a first display screen.

FIG. 5 is a front view of the mobile device of FIG. 4 showing a second display screen.

FIG. 6 is a front view of the mobile device of FIG. 4 showing a third display screen.

### DETAILED DESCRIPTION

The present invention is a computer program and method that uses facial recognition software to match people with similar facial features at a location and display the matched people.

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,”another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flowcharts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable storage mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blue-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

In the following, the term “object” may represent a device or a person that generates an audio signal. For example, the object may include one of a musical instrument, an instrument player, a vocalist, a talker, a speaker that generates accompaniment or sound effect, and a background that generates ambience. The term “audio file” may represent audio data for an audio signal generated from each object.

In the following, the term “metadata” may represent information for describing a property of an audio scene related to at least one audio file. Here, the audio scene may include at least one object and the metadata may include at least one spatial feature of the object. For example, the metadata may include at least one of position information about at least one object, group information representing a position combination of at least two objects, and environment information about a venue in which at least one object is disposed. The venue may include, for example, a studio, a concert hall, a street, and a stadium.

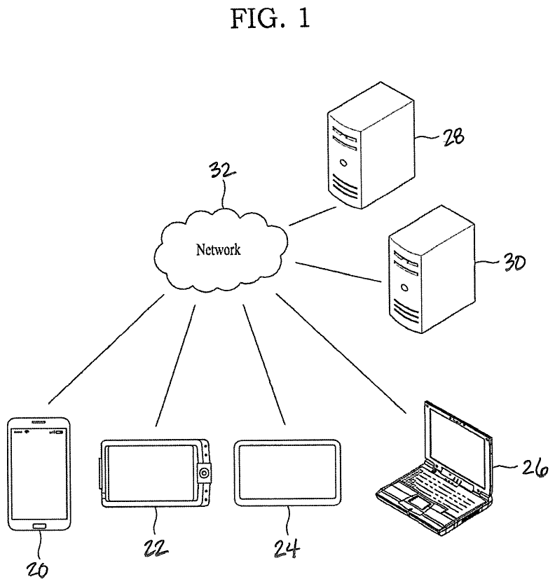

Referring now to FIGS. 1-6, the present invention provides a method and a computer program product such as an application for a mobile telephone, that uses facial recognition technology to match people with similar facial features to their current locations. The application may be used in a variety of ways, such as finding lost twins, making new friends, or simply finding someone who looks familiar.

Referring to FIG. 1, a network environment may include a plurality of electronic devices 20, 22, 24 and 26, a plurality of servers 28 and 30, and a network 32. FIG. 1 is provided as an example only. The number of electronic devices or the number of servers is not limited those shown in FIG. 1. Also, the network environment of FIG. 1 is provided as an example among environments applicable to the example embodiments and the environment applicable to the example embodiments is not limited to the network environment of FIG. 1.

Each of the plurality of electronic devices 20, 22, 24 and 26 may be a fixed terminal or a mobile terminal or mobile device, that is configured as a computer device. For example, the plurality of electronic devices 20, 22, 24 and 26 may be a smartphone, a mobile phone, a navigation device, a computer, a laptop computer, a digital broadcasting termi-nal, a personal digital assistant (PDA), a portable multime-dia player (PMP), a tablet personal computer (PC), and the like. For example, although FIG. 1 illustrates a shape of a smartphone as an example of the electronic device 20, the electronic device 20 used herein may refer to one of various types of physical computer devices capable of communicating with other electronic devices 22, 24 and 26, and/or the servers 28 and 30 over the network 32 in a wireless or wired communication manner.

Each of the servers 28 and 30 may be configured as a computer device or a plurality of computer devices that provides an instruction, a code, a file, content, a service, etc., through communication with the plurality of electronic devices 20, 22, 24 and 26 over the network 32. For example, the server 30 may be a system that provides a service to the plurality of electronic devices 20, 22, 24 and 26 connected over the network 32. It should be appreciated that the network shown in FIG. 1 may include one server or a plurality of servers.

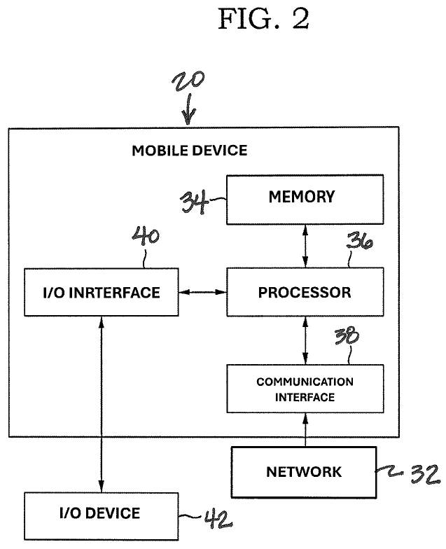

FIG. 2 is a block diagram illustrating an example of a computer device, such as a smartphone, according to an example embodiment. Each of the plurality of electronic devices 20, 22, 24 and 26 of FIG. 1 or each of the servers 28 and 30 may be implemented by a computer device 20 illustrated in FIG. 2.

Referring to FIG. 2, the computer device 20 may include a memory 34 a processor 36, a communication interface 38, and an input/output (I/O) interface 40. The memory 34 may include a permanent mass storage device, such as a random access memory (RAM), a read only memory (ROM), and a disk drive, as a non-transitory computer-readable record medium. The permanent mass storage device, such as ROM and a disk drive, may be included in the computer device 20 as a permanent storage device separate from the memory 34. Also, an operating system (OS) and at least one program code may be stored in the memory 34. Such software components may be loaded to the memory 34 from another non-transitory computer-readable record medium separate from the memory 34. The other non-transitory computer-readable record medium may include a non-transitory computer-readable record medium, for example, a floppy drive, a disk, a tape, a DVD/CD-ROM drive, a memory card and other suitable devices. According to other example embodiments, software components may be loaded to the memory 34 through the communication interface 38, instead of the non-transitory computer-readable record medium. For example, the software components may be loaded to the memory 34 of the computer device 20 based on a computer program installed by files received over the network 32.

The processor 36 may be configured to process instructions of a computer program by performing basic arithmetic operations, logic operations, and I/O operations associated with the I/O interface 40 and/or an external I/O device 42. The computer-readable instructions may be provided from the memory 34 or the communication interface 38 to the processor 36. For example, the processor 36 may be configured to execute received instructions in response to the program code stored in the storage device, such as the memory 34.

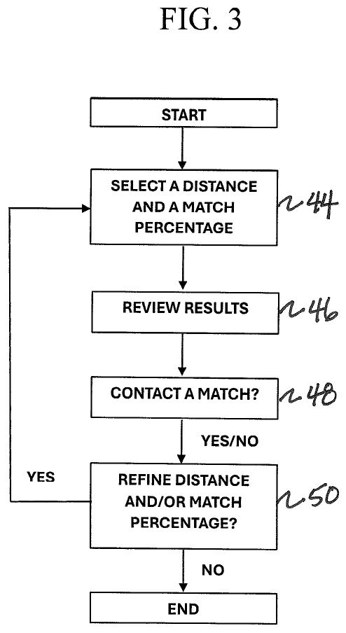

FIG. 3 is a flow diagram illustrating the steps associated with the computer program on the mobile device 20 shown in FIG. 2. It should be appreciated that the computer program and method may be implemented on a mobile device or any suitable computer device or electronic device as described above, such as electronic devices 20, 22, 24 and 26.

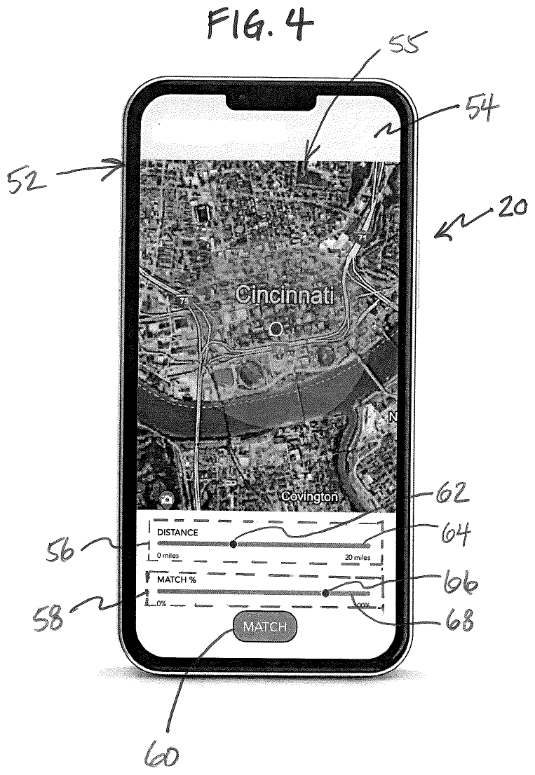

Referring to FIGS. 3 and 4, a user uses a computer device, such as the smartphone 20 shown in FIG. 4, where the smartphone 20 includes a display device 52 having a touchscreen 54 that enables the user to touch and manipulate different inputs and/or functions displayed on the touchscreen 54. In an embodiment, the touchscreen 54 includes a geographic display 55, a distance input 56, a match percentage input 58 and a match activator input 60.

In step 44, the user selects a distance or distance range that the user wants to search within using the distance input 56. This distance range is relative to the user's current location determined by a location module stored in the processor of the computer device or smartphone. In the illustrated embodiment, the distance input has a sliding input 62 that moves or slides between ends of a bar 64. In this embodiment, the distance range associated with the bar 64 is zero miles to twenty miles. It is contemplated that the distance range may be any suitable distance range and may be a predetermined distance range or a distance range set by the user in a settings input associated with the computer program. The user touches the sliding input 62 and slides it to a desired distance within the distance range on the touchscreen. The selected distance range is based on the location of the user when using the computer program, i.e., the current location of the user. In another embodiment, the user selects a particular area, such as a specific city, for the selected distance range, where the user may or may not be in the selected area or selected city. For example, the user may choose to have the selected distance range to be associated with a city that the user is not presently in. The geographic display 55 changes the display of the geographic region simultaneously with the sliding of the sliding input 62 along the bar 64 to show the user the geographic area or location selected by the user.

After selecting the distance range, the user selects a match percentage on the match percentage input 58. The match percentage input 58 includes a sliding input 66 that moves or slides along a bar 68. In this embodiment, the match percentage range associated with the bar 68 is 0% to 100%. The user touches the sliding input 66 and moves it to a desired match percentage. The match percentage is the degree of matching between the user's facial features and the facial features of one or more people within the selected geographic range or area. For example, a selected match percentage of 75% requires matching of more facial features than a selected match percentage of 50%. After the distance range and the match percentage are selected by the user, the user touches the match activator input 60 to activate the facial recognition process.

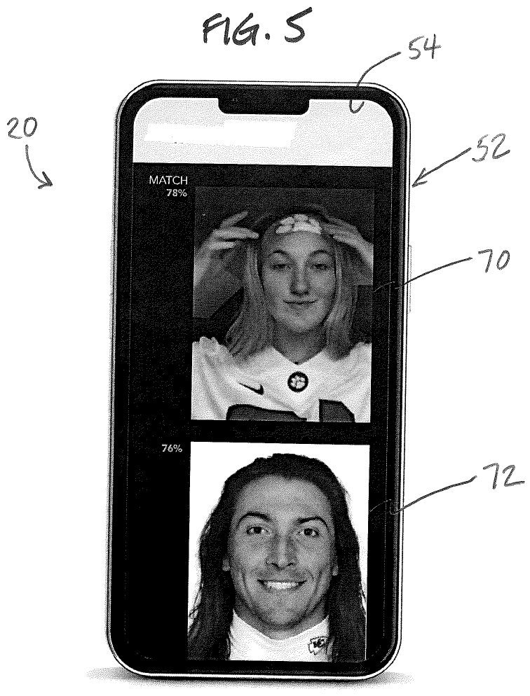

The computer program or facial recognition module stored in the processor of the smartphone, uses a facial recognition program, such as facial recognition software loaded to the processor of the mobile device 20, and searches for facial matches with the user within the selected geographic area and based on the selected match percentage. A matching module stored in the processor, performs matching facial features based on the facial features found by the facial recognition module and selected match percentage. In step 46 in FIG. 3, the display device 52 displays the results of the facial recognition process completed by the facial recognition program as shown in FIG. 5. In the illustrated embodiment, the display device 52 displays two matches on the touchscreen 54. The first match 70 and a second match 72 display people within the selected distance range and based on the selected match percentage. The display device 52 may display one or more matches on the touchscreen 54 or one or matches on different screen segments of the touchscreen 54 by scrolling between the screen segments using one or more inputs on the smartphone or by the user using their finger to touch and scroll through the screen segments on the touchscreen. In the illustrated embodiment, the first match 70 has a match percentage of 78%, which means that the facial features of the first match 70 match with 78% of the facial features of the user. The criteria for the matching function of the facial recognition program depend on a number of factors and calculations that are preprogrammed in the facial recognition program. The second match 72 has a match percentage of 76%, which means that the facial features of the second match 72 match with 76% of the facial features of the user.

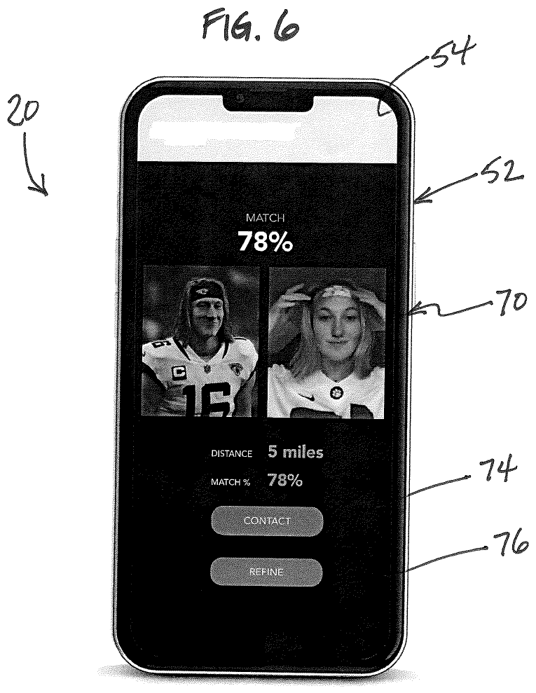

In step 48 of FIG. 3, the user reviews the matches shown on the touchscreen 54 and decides whether they want to contact the first match 70, the second match 72 or both the first match 70 and the second match 72. As shown in FIG. 6, the user selected the first match 70 on the touchscreen 54 in FIG. 5. The touchscreen 54 then displays the first match 70, the match percentage of 78%, the selected distance of 5 miles and the selected match percentage of 78%. If the user wants to contact the first match 70, the user selects or touches the contact input 74 on the touchscreen 54. After touching the contact input 54, the mobile device 20 contacts the first match 70 by calling the first match, texting the first match, through social media or by any predetermined method of contact. In an embodiment, users may opt to not be contacted through the computer program.

In another step 50 in FIG. 3, the user may also decide to refine or change the selected range and/or selected match percentage by touching the refine input 76. For example, the user may change the selected distance range of 5 miles to 10 miles or another distance range. Similarly, the user may change the selected match percentage from 78% to 90% or to 20% or any suitable match percentage from 0% to 100%. It should be appreciated that the user may change the selected distance range, the selected match percentage or both the selected distance range and the selected match percentage. In this embodiment, if the user touches the refine input 76, the display device 52 changes the display on the touchscreen 54 back to the display on the touchscreen shown in FIG. 4.

While particular embodiments of the present method, computer device and computer-implemented computer program product are shown and described, it will be appreciated by those skilled in the art that changes and modifications may be made thereto without departing from the invention in its broader aspects and as set forth in the following claims.

What is claimed is:

1. A computer apparatus comprising:
a memory device configured to store an instruction executable on a computer; and
at least one processor configured to execute the instruction, the processor including
a facial recognition module for identifying facial features of a user;
a location module for determining the location of the user; and
a matching module for matching the facial features of the user to the facial features of other users in a distance range of the user and providing the user with information about the other users; and
a display device configured to display the results of the matching of the facial features withing a selected distance range and match percentage.

2. The computer apparatus of claim 1, wherein the matching module uses a machine learning algorithm to identify users with similar facial features.

3. The computer apparatus of claim 1, wherein the matching module uses a social network to identify users with similar facial features.

4. The computer apparatus of claim 1, wherein the matching module uses a database of facial features to identify users with similar facial features.

5. The computer apparatus of claim 1, wherein the matching module provides the user with information about the other users using generic names and approximate ages, and locations in order to protect privacy.

6. The computer apparatus of claim 1, wherein the matching module provides the user with a map of the vicinity of the user, with the locations of the other users overlaid on the map.

7. The computer apparatus of claim 1, wherein the matching module provides the user with a list of the other users, with the names and locations of the other users listed.

8. The computer apparatus of claim 1, wherein the matching module provides the user with a notification when a user with similar facial features is detected in the vicinity of the user.

9. The computer apparatus of claim 1, wherein the matching module provides the user with a way to contact the other users.

10. The computer apparatus of claim 1, wherein the matching module provides the user with a way to share information about the other users with others.

11. The computer apparatus of claim 1, wherein the matching module will require a current geotagged location with the participant's picture in order to assure the authenticity of both users and potentially prevent the misuse of AI generated faces and users with nefarious intentions.

12. A matching method performed by at least one processor of a computer apparatus, the method comprising:
identifying facial features of a user;
determining a location of the user;
selecting a distance range relative to the location of the user;
selecting a match percentage associated with the facial features of the suer and other users in the selected distance range;
matching the facial features of the user to facial features of other users in the selected distance range of the user;
storing information on the other users that have similar facial features to the user; and
displaying the information on a display device to the user.

13. The method claim 12, wherein the matching step uses a machine learning algorithm stored in a processor to identify users with similar facial features.

14. The method of claim 12, wherein the matching step uses a social network to identify users with similar facial features.

15. The method of claim 12, wherein the matching step uses a database of facial features to identify users with similar facial features.

16. The method of claim 12, wherein the matching step provides the user with information about the other users using generic names and approximate ages, and locations to protect privacy.

17. The method of claim 12, wherein the matching step displays a vicinity of the user relative to the locations of the other users overlaid on the map.

18. The method of claim 12, wherein the matching step provides the user with a list of the other users, with the names and locations of the other users on the list.

19. The method of claim 12, wherein the matching step provides the user with a notification when a user with similar facial features is detected in the vicinity of the user.

20. The method of claim 12, wherein the matching step provides the user with a way to contact the other users.
